(19) United States
(12) Patent Application Publication
(10) Pub. No.: US 2023/0011409 A1
(43) Pub. Date: Jan. 12, 2023

(54) METHOD OF MANAGING THERMAL ENERGY IN A PROPULSION SYSTEM

(71) Applicant: General Electric Company, Schenetady, NY (US)

(72) Inventors: Jeffrey Douglas Rambo, Mason, OH (US); Brandon Wayne Miller, Liberty Township, OH (US); Scott Gregory Edens, Milford, OH (US)

(21) Appl. No.: 17/373,127

(22) Filed: Jul. 12, 2021

(51) Int. Cl. F02C 7/18; F02C 7/22; F02C 7/36; F02C 6/08

(52) U.S. Cl. CPC F02C 7/185; F02C 7/22; F02C 7/36; F02C 6/08; F05D 2220/76; F05D 2260/213; F05D 2260/232

(57) ABSTRACT

A method of managing thermal energy in a propulsion system includes diverting a flow of bleed air from a compressor section of the propulsion system. An amount of the flow of bleed air diverted from the compressor section is at least 5% of an inlet flow at an inlet of a high pressure compressor of the compressor section. The flow of bleed air is provided to a thermal management system. The flow of bleed air is passed through an expansion turbine of the thermal management system. The flow of bleed air is provided to a thermal load.

### FIELD

The present disclosure relates to thermal energy management in a propulsion system. In particular, the present disclosure relates to managing a flow of bleed air from a compressor in a propulsion system.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly.

Typically, gas turbine engines incorporate the use of one or more thermal management systems to control thermal energy of various fluids passing through the various components of the engine. The thermally managed fluids can then be utilized by the engine or by other portions of the aircraft, such as an environmental control system, an auxiliary power unit, or an air cycle machine.

In existing thermal management systems for propulsion systems such as gas turbine engines, various small centrifugal compressors are incorporated to manage and cool air flows. The inventors of the present disclosure have found that such small compressors can be inefficient due to large ratio(s) of tip clearance to blade height in the compressors. Improvements to such thermal management systems would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a simplified schematic view of an engine and a first high-bleed compressor architecture thermal management system.

FIG. 3 is a simplified schematic view of an engine and a second high-bleed compressor architecture thermal management system.

FIG. 4 is a simplified schematic view of an engine and a third high-bleed compressor architecture thermal management system.

FIG. 5 is a simplified schematic view of an engine and a fourth high-bleed compressor architecture thermal management system.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure is generally related to thermal management systems for propulsion systems. The disclosed thermal management systems take a relatively large amount of bleed air off of the high pressure compressor and drives a pre-cooling system with the bleed air. The present disclosure provides a variety of effective uses of the bleed air from the high pressure compressor.

The proposed high-bleed architecture helps to increase stall margin and avoid additional fuel flow at low power. Further, although more airflow is bled from the high pressure compressor, lowering an efficiency of the compressor section from an overall propulsion system, such a configuration allows for the thermal management system to operate without a dedicated compressor having a low efficiency relative to the compressor section of the engine, thus resulting in a net efficiency benefit to the overall system.

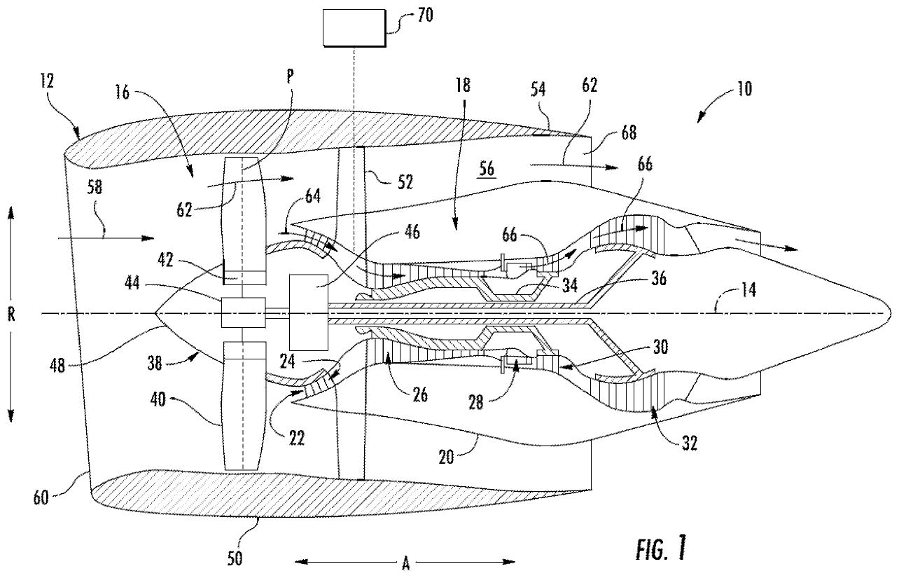

Referring now to the drawings, wherein identical numerals indicate the same elements throughout the figures, FIG. 1 is a schematic, cross-sectional view of a propulsion system 10 in accordance with an exemplary embodiment of the present disclosure. More particularly, for the embodiment of FIG. 1, propulsion system 10 includes a gas turbine engine, referred to herein as “turbofan engine 12.” In one example, turbofan engine 12 can be a high-bypass turbofan jet engine. As shown in FIG. 1, turbofan engine 12 defines an axial direction A (extending parallel to longitudinal centerline 14 provided for reference) and a radial direction R. In general, turbofan engine 12 includes a fan section 16 and a core turbine engine 18 disposed downstream from fan section 16.

The exemplary core turbine engine 18 depicted generally includes a substantially tubular outer casing 20 that defines an annular inlet 22. Outer casing 20 encases, in serial flow order/relationship, a compressor section including a booster or low pressure compressor 24 (“LP compressor 24”) and a high pressure compressor 26 (“HP compressor 26”); a combustion section 28; a turbine section including a high pressure turbine 30 (HP turbine 30″) and a low pressure turbine 32 (“LP turbine 32”); and a combustion section 28. A high pressure shaft or spool 34 (“HP spool 34”) drivingly connects HP turbine 30 to HP compressor 26. A low pressure shaft or spool 36 (“LP spool 36”) drivingly connects LP turbine 32 to LP compressor 24.

For the embodiment depicted, fan section 16 includes a variable pitch fan 38 having a plurality of fan blades 40 coupled to a disk 42 in a spaced apart manner. As depicted, fan blades 40 extend outwardly from disk 42 generally along radial direction R. Each fan blade 40 is rotatable relative to disk 42 about a pitch axis P by virtue of fan blades 40 being operatively coupled to a suitable actuation member 44 configured to collectively vary the pitch of fan blades 40, e.g., in unison. Fan blades 40, disk 42, and actuation member 44 are together rotatable about longitudinal centerline 14 by LP spool 36 across a power gear box 46. Power gear box 46 includes a plurality of gears for stepping down the rotational speed of LP spool 36 to a more efficient rotational fan speed.

Referring still to the exemplary embodiment of FIG. 1, disk 42 is covered by a rotatable front hub 48 aerodynamically contoured to promote an airflow through the plurality of fan blades 40. Additionally, fan section 16 includes an annular fan casing or outer nacelle 50 that circumferentially surrounds variable pitch fan 38 and/or at least a portion of core turbine engine 18. It should be appreciated that in some embodiments, nacelle 50 can be configured to be supported relative to core turbine engine 18 by a plurality of circumferentially spaced outlet guide vanes 52. Moreover, a downstream section 54 of nacelle 50 can extend over an outer portion of core turbine engine 18 so as to define a bypass airflow passage 56 therebetween.

During operation of turbofan engine 12, a volume of air 58 enters turbofan engine 12 through an associated inlet 60 of nacelle 50 and/or fan section 16. As the volume of air 58 passes across fan blades 40, a first portion of air 58 as indicated by arrows 62 is directed or routed into bypass airflow passage 56 and a second portion of air 58 as indicated by arrow 64 is directed or routed into LP compressor 24. The ratio between first portion of air 62 and second portion of air 64 is commonly known as a bypass ratio. The pressure of second portion of air 64 is then increased as it is routed through high pressure (HP) compressor 24 and into combustion section 28, where it is mixed with fuel and burned to provide combustion gases 66. Subsequently, combustion gases 66 are routed through HP turbine 30 and LP turbine 32, where a portion of thermal and/or kinetic energy from combustion gases 66 is extracted.

Combustion gases 66 are then routed through combustion section 28 of core turbine engine 18 to provide propulsive thrust. Simultaneously, the pressure of first portion of air 62 is substantially increased as first portion of air 62 is routed through bypass airflow passage 56 before it is exhausted from fan nozzle exhaust section 68 of turbofan engine 12, also providing propulsive thrust.

Moreover, as is depicted schematically, turbofan engine 12 further includes various accessory systems to aid in the operation of turbofan engine 12 and/or an aircraft including turbofan engine 12. For example, turbofan engine 12 may further include a lubrication system configured to provide a lubricant to, e.g., various bearings and gear meshes in the compressor section (including LP compressor 24 and HP compressor 26), the turbine section (including HP turbine 30 and LP turbine 32), HP spool 34, LP spool 36, and power gear box 46. The lubricant provided by the lubrication system increases the useful life of such components and removes a certain amount of heat from such components.

As is also depicted schematically, turbofan engine 12 drives or enables various other accessory systems for an aircraft including turbofan engine 12. For example, turbofan engine 12 provides compressed air from the compressor section to a thermal management system 70. Although depicted schematically as coming from a location between LP compressor 24 and HP compressor 26, in certain exemplary aspects thermal management system 70 may receive compressed air from HP compressor 26, from an exit of HP compressor 26, or both.

It should be appreciated, however, that turbofan engine 12 depicted in FIG. 1 is by way of example only, and that in other exemplary embodiments, aspects of the present disclosure may additionally, or alternatively, be applied to any other suitable gas turbine engine. For example, in other exemplary embodiments, turbofan engine 12 may instead be any other suitable aeronautical gas turbine engine, such as a turbojet engine, turboshaft engine, turboprop engine, etc. Additionally, in still other exemplary embodiments, turbofan engine 12 may include or be operably connected to any other suitable accessory systems. Additionally, or alternatively, turbofan engine 12 may not include or be operably connected to one or more of the accessory systems discussed above.

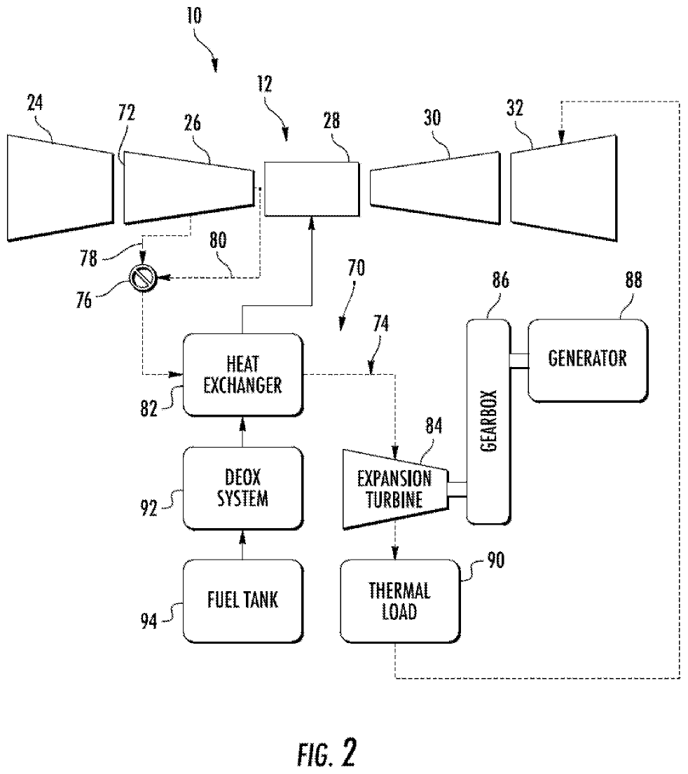

FIG. 2 is a simplified schematic view of a propulsion system 10 and shows a turbofan engine 12 and a thermal management system 70. Turbofan engine 12 may be configured in substantially the same manner as the exemplary turbofan engine 12 of FIG. 1. In this example, turbofan engine 12 is an aeronautical gas turbine engine. HP compressor 26 defines an inlet 72 located at an upstream end of HP compressor 26.

As shown, thermal management system 70 is a thermal energy management system. A thermal management system flowpath 74 is defined by thermal management system 70 and is a flowpath of air from HP compressor 26 that flows to and/or through the components of thermal management system 70. Thermal management system 70 is configured to receive a flow of bleed air extracted from the compressor section (e.g., from HP compressor 26) through thermal management system flowpath 74.

Thermal management system 70 also includes a switch 76. Switch 76 is a flow control device. Here, switch 76 can be a fluidic valve, such as a three-way variable throughput fluidic valve. In this example, switch 76 is bleed port switch. In other examples, switch 76 can include a system of open/close valves and check valves. Switch 76 is fluidly connected to inlet 72 of HP compressor 26 via a first line 78. First line 78 defines in part thermal management system flowpath 74. First line 78 also is fluidly connected to and extends from HP compressor 26. Additionally, switch 76 is fluidly connected to an interface between HP compressor 26 and combustion section 28 via a second line 80 (e.g., an outlet of HP compressor 26). Switch 76 controls an amount of fluid (e.g., air flow) from both of first line 78 and of second line 80 to heat exchanger 82. In this example, switch 76 modulates a mass flow rate of the flow of bleed air provided to an expansion turbine 84.

Thermal management system 70 further includes a heat exchanger 82. In this example, heat exchanger 82 is a fuel-cooled heat exchanger. Heat exchanger 82 is thermally connected to thermal management system flowpath 74 and to combustion section 28. Heat exchanger 82 is fluidly connected to HP compressor 26 and to combustion section 28. Heat exchanger 82 receives liquid fuel and transfers thermal energy between the liquid fuel and the flow of air received from switch 76. More specifically, in at least certain exemplary aspects, heat exchanger 82 transfers thermal energy from the flow of air received from switch 76 to the liquid fuel.

Thermal management system 70 also includes an expansion turbine 84 which receives the flow of air passing through heat exchanger 82. In this example, expansion turbine 84 is a pre-cooled bleed air expander. Expansion turbine 84 is fluidly connected to thermal management system flowpath 74 at a location downstream of heat exchanger 82. Expansion turbine 84 is configured to expand the flow of air received from heat exchanger 82. As expansion turbine 84 expands the flow of air, a thermal energy of the flow of air is reduced. In one example, the thermal energy of the flow of air can be reduced so that a temperature of the flow of air drops down to less than a temperature of ambient air.

Additionally, thermal management system 70 includes a gearbox 86 and a generator 88. Gearbox 86 is operably coupled to expansion turbine 84. Gearbox 86 is configured to transfer rotational energy from expansion turbine 84 to generator 88. For example, as expansion turbine 84 expands a flow of air from heat exchanger 82, expansion turbine 84 (or an internal component thereof) rotates. As expansion turbine 84 rotates, torque is transferred from expansion turbine 84 to gearbox 86. Gearbox 86 can then then transfer the torque to other components of propulsion system 10 such as to generator 88. In this way, expansion turbine 84 can provide torque to turbofan engine 12 via a mechanical means (e.g., via gearbox 86). In this example, generator 88 is an electrical generator. For example, as torque is transferred to generator 88, generator 88 converts the torque into electrical power for electric accessories or to increase a vehicle power source of propulsion system 10.

After the flow of air from heat exchanger 82 passes through expansion turbine 84, the flow of air then travels to a thermal load 90. Thermal load 90 is a component or an element of a vehicle to which propulsion system 10 is attached that utilizes the flow of air for thermal energy transfer. For example, thermal load 90 can include one or more of a heat sink for vehicle heat rejection or a sink for a thermal management system of the engine such as oil cooling, sump air cooling, and/or cooled cooling air or bleed air cooling. Thermal load 90 is thermally connected to thermal management system flowpath 74.

After passing through thermal load 90, the flow of air can then be discharged from thermal load 90 and delivered to LP turbine 32 for cooling and/or for clearance control of either HP turbine 30 or LP turbine 32. In other examples, the flow of air discharged from thermal load 90 can be delivered to one or more of an exhaust turbine (e.g., of fan nozzle exhaust section 68), an active clearance control system, an engine bay, or be sent overboard to ambient.

Referring back to heat exchanger 82, heat exchanger 82 is fluidly connected to a deoxygenation system 92 which is fluidly connected to a fuel tank 94. Deoxygenation system 92 is a system configured to remove or otherwise reduce oxygen within a liquid fuel of propulsion system 10. For example, the resultant fuel output from deoxygenation system 92 can be a deoxygenated fuel whereby combustion of the deoxygenated fuel provides a driving force of turbofan engine 12 via combustion section 28. In certain exemplary embodiments, the deoxygenated fuel may have an oxygen content of less than or equal to about 5 parts per million down to 1 part per million to allow the fuel thought heat exchanger 82 to accept a larger amount of heat without appreciably degrading or coking. Deoxygenation system 92 may utilize a stripping gas, one or more membranes, etc. to remove or convert oxygen within the liquid fuel of propulsion system 10.

Fuel tank 94 is a reservoir of liquid fuel for the aircraft. Fuel tank 94 is fluidly connected to deoxygenation system 92. In one example, fuel tank 94 can be located in a wing or in a fuselage of an aircraft to which propulsion system 10 is attached.

The fuel system of deoxygenation system 92 and fuel tank 94 is configured to provide a coolant to heat exchanger 82. The fuel system includes fuel tank 94 and deoxygenation system 92 positioned between and fluidly connected to fuel tank 94 and to heat exchanger 82.

In one example, a method of managing thermal energy in propulsion system 10 includes diverting a flow of bleed air from a compressor section of propulsion system 10. In this example, the flow of bleed air diverted from the compressor section is diverted from HP compressor 26 through first line 78. An additional portion of the flow of bleed air can be diverted from an interface between HP compressor 26 and combustion section 28 via second line 80, depending on the power mode of propulsion system 10.

An amount of the flow of bleed air diverted from the compressor section is at least 5% of an inlet flow at inlet 72 of HP compressor 26 of the compressor section. In one example, the amount of the flow of bleed air diverted from the compressor section is greater than or equal to 10% and less than or equal to 25% of the inlet flow at inlet 72 of the compressor section, such as greater than or equal to about 15% of the inlet flow at inlet 72 of the compressor section.

In another example, the amount of the flow of bleed air diverted from the compressor section is greater than or equal to 10% of the inlet flow at inlet 72 of the compressor section (such as greater than or equal to 15%, such as less than 25%) when a power level of propulsion system 10 is less than 50% of a maximum rated power level of propulsion system 10 (such as less than 40% of the maximum rated power level of propulsion system 10, such as less than 20% of the maximum rated power level of propulsion system 10). The term “maximum rated power level” refers to the amount of power propulsion system 10 generates during operation at a maximum rated speed during standard day operating conditions. In another example, the amount of the flow of bleed air diverted from the compressor section is greater than or equal to 5% of the inlet flow at inlet 72 of the compressor section (such as greater than or equal to 10%, such as greater than or equal to 15%, such as less than 25%) when a power level of propulsion system 10 is greater than or equal to 70% (such as greater than or equal to 75%) of the maximum rated power level of propulsion system 10. In general, aircraft engines are sized to meet maximum thrust requirements. In order to meet maximum thrust requirements, minimizing the percentage of bleed flow can help with not having to oversize core turbine engine 18 of propulsion system 10 in order to meet thermal management requirements.

During part-power operating conditions, core turbine engine 18 of propulsion system 10 is working at less than full capacity and can afford to have additional air bled from HP compressor 26. In some examples, thermal management system 70 may require a minimum amount of physical air flow, which in one instance can be met by 5% of an inlet flow of HP compressor 26 at a high engine power (e.g., such as greater than 70% of the maximum rated power level, such as greater than 75% of the maximum rated power level, such as greater than 85% of the maximum rated power level) that is comparable to another instance with 15% of an amount of the inlet flow of HP compressor 26 at a lower engine power (e.g., less 50%, 40%, or 20% of the maximum rated power level).

In another example, the amount of the flow of bleed air diverted from the compressor section is greater than or equal to 10% of the inlet flow at inlet 72 of the compressor section (such as greater than or equal to 15%, such as less than 25%) when an engine speed of propulsion system 10 is less than 50% of a maximum rated speed of propulsion system 10, such as less than 40% of the maximum rated speed of propulsion system 10, such as less than 20% of the maximum rated speed of propulsion system 10. The term “maximum rated speed” refers to the amount of speed propulsion system 10 operates at during operation at a maximum rated power level during standard day operating conditions. In another example, the amount of the flow of bleed air diverted from the compressor section is greater than or equal to 5% of the inlet flow at inlet 72 of the compressor section (such as greater than or equal to 10%, such as greater than or equal to 15%, such as less than 25%) when the engine speed of propulsion system 10 is greater than 70% of the maximum rated speed of propulsion system 10 (such as greater than 75% of the maximum rated speed of propulsion system 10, such as greater than 85% of the maximum rated speed of propulsion system 10).

The flow of bleed air diverted from the compressor section is then provided to thermal management system 70. In this example, the flow of bleed air is provided to switch 76 which modulates a mass flow rate of the flow of bleed air provided to expansion turbine 84. Further, the flow of bleed air is provided to heat exchanger 82 before the flow of bleed air is provided to expansion turbine 84. The flow of bleed air is cooled with heat exchanger 82. A coolant is provided from a fuel system (including deoxygenation system 92 and fuel tank 94) to heat exchanger 82. In this example, the coolant is liquid fuel.

The flow of bleed air is then delivered to and passed through expansion turbine 84 of thermal management system 70. In one example, passing the flow of bleed air through expansion turbine 84 includes driving a turbine element of expansion turbine 84 with the flow of bleed air. The flow of bleed air is expanded with expansion turbine 84. An output torque is generated by expansion turbine 84 via expanding the at least a portion of the flow of bleed air across expansion turbine 84. In this example, the output torque is delivered from expansion turbine 84 to generator 88. A thermal energy of the flow of bleed air is then decreased with expansion turbine 84 in response to the flow of bleed air being expanded. After the flow of bleed air passes through expansion turbine 84, the flow of bleed air is provided to thermal load 90.

In certain exemplary embodiments, a stall margin of turbofan engine 12 can be maintained. More specifically, in at least certain exemplary aspects, a method of managing thermal energy in propulsion system 10 can include maintaining a stall margin of at least 10% (such as at least 15%, such as at least 20%, such as up to about 40%). For example, the stall margin of turbofan engine 12 can be maintained by bleeding the flow of bleed air from the compressor section and flowing the flow of bleed air through expansion turbine 84. As used herein, “stall margin” can be defined by Equation 1.1 provided below.

stall margin=(PRₛₜₐₗₗ−PR_{operating})/PR_{operating} Equation 1.1

As provided herein, the value Cr_{ystal} is defined as a pressure ratio of a stall condition of the compressor section at a given corrected flow rate. In this example, the term “pressure ratio” can be defined as the ratio of the pressure at the exit (e.g., downstream outlet of LP turbine 32) of turbofan engine 12 divided by the pressure at the entry (e.g., annular inlet 22) to the compressor section. The value PR_{operating} is defined as a pressure ratio or a normal operating line of the compressor section.

Here, thermal management system 70 provides a solution that improves engine performance by increasing a compressor stall margin and reducing part-power fuel burn. As a result, there is an added fuel burn benefit by increasing stall margin at low power conditions thereby reducing additional fuel needed to maintain a speed of HP spool 34. Accordingly, turbofan engine 12 and thermal management system 70 provide a highly thermodynamically efficient solution over existing designs.

Due to the high-bleed/high pressure compressor architecture of thermal management system 70 coupled with heat exchanger 82 and the pre-cooled bleed air expander (e.g., expansion turbine 84), propulsion system 10 provides a very thermodynamically efficient thermal energy management solution.

For example, existing engine designs may incorporate several small compressors and turbines for air cycle machines and dedicated refrigeration cycles. An issue with small compressors is that with the smaller the compressor, the tip clearance becomes a large source of inefficiency due to a large ratio of tip clearance to blade height. Here, thermal management system 70 provides a more thermodynamically efficient solution because thermal management system 70 pulls bleed air from HP compressor 26 which is an efficient compressor due to its size and relative tip clearance.

Additionally, thermal management system 70 provides cold air for cooling, for electric power generation, and for increased operability of propulsion system 10. Moreover, due to pulling bleed air from HP compressor 26, thermal management system 70 is a thermal management solution that can be scaled or adapted to other engine programs. As such, the benefits of the architecture of propulsion system 10 can be applied across many different engine sizes and engine types.

By utilizing expansion turbine 84, thermal management system 70 can produce sub-ambient (less than TO) temperatures for cooling various components of propulsion system 10. Likewise, work developed from expansion turbine 84 can be used to either drive gearbox 86 in order to offset core parasitic torque or to drive a boost pump for lowering a bleed stage of HP compressor 26.

In existing designs, certain engines incorporate a transient bleed valve to tune the compressor to run at certain conditions. For example, air is bled out of the compressor at lower power levels until the engine power level increases at which point the transient bleed valve can be closed. Here, the need for a discrete transient bleed valve is eliminated because thermal management system 70 enables a push of operability bleed air through expansion turbine 84 to extract work and to generate cooling. For example, thermal management system 70 can be used to replace a dedicated transient bleed valve by throttling thermal management system 70 up or down based on the needs of HP compressor 26.

Moreover, propulsion system 10 with thermal management system 70 is different than certain existing designs in that the more bleed air that is drawn from HP compressor 26, the higher the cooling benefit from thermal management system 70. Whereas in existing designs, the typical approach is to minimize an amount of bleed air taken from the compressor section.

Additionally, certain traditional engine designs want to minimize the amount of flow of bleed air in order to maximize an amount of work performed by HP turbine 30, resulting in increased fuel flow at low power conditions (e.g., ground idle and flight idle) to increase a speed of HP spool 34 and avoid a stall condition of HP compressor 26. In contrast, the high-bleed architecture of propulsion system 10 inherently lowers an operating line of the compressor section by taking more bleed air flow at the same pressure ratio, thereby increasing stall margin and avoiding additional fuel flow at low power conditions.

It will be appreciated that the embodiments disclosed herein may also include non-aeronautical gas turbine engines. In yet further embodiments, thermal management system 70 can be incorporated into vertical lift applications. For example, with bleed air being drawn from inlet 72 of HP compressor 26, other external sources of air (e.g., a fan stream or a RAM scoop) besides those provided by thermal management system 70 can be omitted in order to meet cooling demand or power generation requirements of propulsion system 10 or of the vehicle to which propulsion system 10 is attached.

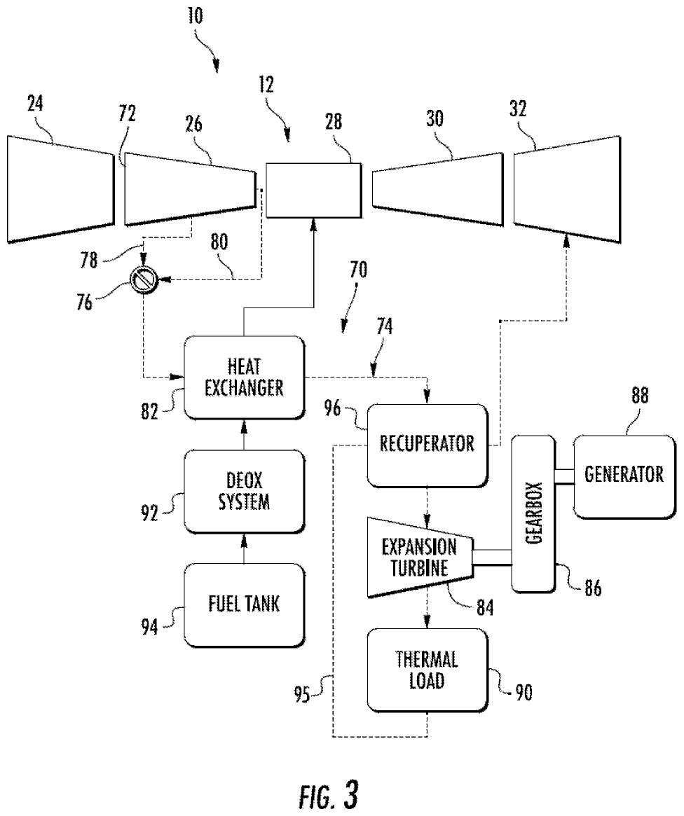

FIG. 3 is a simplified schematic view of propulsion system 10 with turbofan engine 12 and thermal management system 70. As shown, FIG. 3 includes the same or similar components as described above with respect to FIG. 2, with the addition of a recuperator 96.

Recuperator 96 is a component configured for the transfer of thermal energy between two fluids. In this example, recuperator 96 is a recuperative or recuperating heat exchanger. Recuperator 96 is fluidly connected between heat exchanger 82 and expansion turbine 84. Recuperator 96 is also fluidly connected between thermal load 90 and LP turbine 32 of the turbine section of turbofan engine 12.

During operation of thermal management system 70, as a flow of bleed air passes through heat exchanger 82, the flow of bleed air passes through thermal management system flowpath 74 and is delivered to recuperator 96. The flow of bleed air from heat exchanger 82 is a first fluid passing into and through recuperator 96. A second fluid passing into and through recuperator 96 is delivered from thermal load 90. Recuperator 96 functions by transferring thermal energy from the first fluid (e.g., the flow of bleed air from heat exchanger 82) to the flow of fluid coming from thermal load 90.

In an instance where thermal load 90 does not draw all of the cooling benefit from the flow of cooled bleed air from expansion turbine 84, recuperator 96 uses up any residual cooling potential from the flow of fluid coming from thermal load 90 (e.g., transferring thermal energy from the flow of air coming from heat exchanger 82 to the flow of air coming from thermal load 90) to pre-cool the flow of bleed air from heat exchanger 82 before the flow of bleed air is delivered to expansion turbine 84 to be cooled by expansion turbine 84. For example, as used herein the term “uses up” can refer to having recuperator 96 using any residual cooling potential in the airflow from thermal load 90 to pre-cool the flow of bleed air from heat exchanger 82 before the flow of bleed air is delivered to expansion turbine 84. For example, if the flow of air passing through line 95 from thermal load 90 has less thermal energy (is colder) than the flow of bleed air from heat exchanger 82 before the flow of bleed air is delivered to expansion turbine 84, then thermal energy from the flow of bleed air from heat exchanger 82 will transfer thermal energy to the airflow from thermal load 90 at recuperator 96 before the airflow from thermal load 90 is dumped into the LP turbine 32.

In this way, recuperator 96 maximizes the cooling benefit of thermal management system 70 before dumping the flow of fluid coming from thermal load 90 into LP turbine 32, into fan nozzle exhaust section 68 (see e.g., FIG. 1), into an active clearance control of the turbine section, into an engine bay, or overboard to ambient.

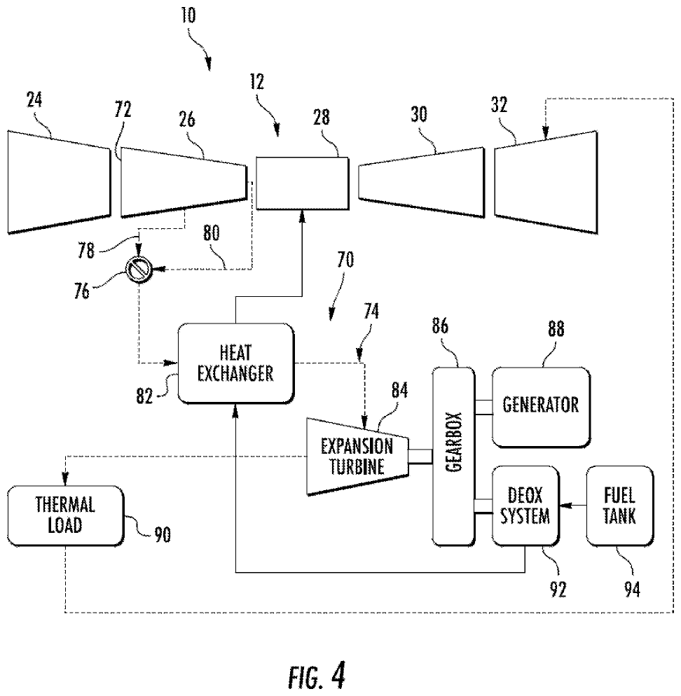

FIG. 4 is a simplified schematic view of propulsion system 10 with turbofan engine 12 and thermal management system 70. As shown, FIG. 4 includes the same or similar components as described above with respect to FIG. 2, while providing a different arrangement of the components.

For example, in FIG. 4, deoxygenation system 92 is operably coupled to gearbox 86 such that gearbox 86 drives deoxygenation system 92.

In this instance, gearbox 86 is being used to drive deoxygenation system 92 in addition to gearbox 86 delivering rotational power to generator 88 for generator 88 to convert into electrical power. For example, deoxygenation system 92 may include a contactor, a separator, etc. requiring a rotational power input. Gearbox 86 in the embodiment of FIG. 4 may directly, or through one or more intermediate components, provide such rotational power. In another example, gearbox 86 can be coupled to an accessory gearbox of propulsion system 10 and use torque created by expansion turbine 84 to put power back onto HP spool 34 (see e.g., FIG. 1).

In this configuration, because deoxygenation system 92 is being driven by expansion turbine 84 via gearbox 86, an amount of power or electricity taken from a different part of propulsion system 10 that would have been used to drive deoxygenation system 92 can now be conserved and/or applied elsewhere in propulsion system 10 thereby increasing the overall efficiency of propulsion system 10.

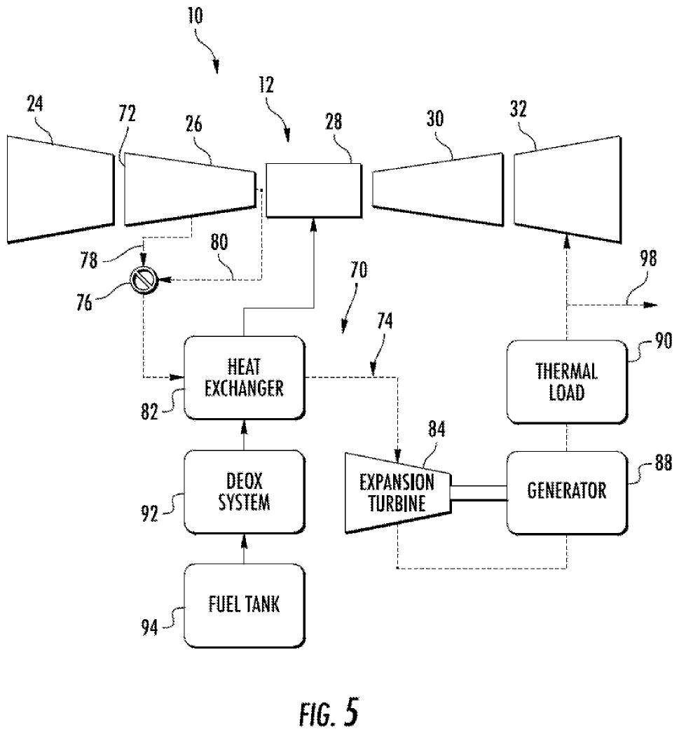

FIG. 5 is a simplified schematic view of propulsion system 10 with turbofan engine 12 and thermal management system 70. As shown, FIG. 5 includes the same or similar components as described above with respect to FIG. 2, with the exclusion of gearbox 86 and the addition of a third line 98.

In this example, expansion turbine 84 is directly connected to generator 88, as compared to expansion turbine 84 being connected to generator 88 via gearbox 86 (as shown in FIGS. 2-4).

Additionally, thermal management system 70 shown in FIG. 5 includes third line 98. Third line 98 connects to thermal management system flowpath 74 at a location between thermal load 90 and LP turbine 32. Here, third line 98 is shown as a dotted arrowhead to indicate that third line 98 can optionally be included or utilized in conjunction with thermal management system 70.

In one example, third line 98 can be in fluid communication with fan nozzle exhaust section 68 (see e.g., FIG. 1) such that third line 98 can divert a portion or all of the flow passing through thermal load 90 to fan nozzle exhaust section 68. In another example, third line 98 can be in fluid communication with ambient such that third line 98 can divert a portion or all of the flow passing through thermal load 90 to ambient atmosphere.

As depicted in FIG. 5, thermal management system 70 is configured such that generator 88 is fluidly connected to expansion turbine 84. For example, generator 88 is disposed downstream from expansion turbine and upstream from thermal load along a downstream direction (depicted by arrowheads of line segments of thermal management system flowpath 74) of thermal management system flowpath 74.

In general, for electrical power generation, a temperature of the generator components needs to stay below the Curie temperature of the material so that the generator stays magnetic. Here, generator 88 receives a flow of cooling fluid directly from expansion turbine 84 to cool generator 88, to maintain a temperature of the magnetic components of generator 88 below their Curie temperatures, and to maximize the efficiency of electrical power generation.

It will be appreciated that any configuration and/or components of thermal management system 70 shown through FIGS. 2-5 can be incorporated or combined with any other components of thermal management systems 70 shown throughout FIGS. 2-5.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects are provided by the subject matter of the following clauses:

A method of managing thermal energy in a propulsion system includes diverting a flow of bleed air from a compressor section of the propulsion system. An amount of the flow of bleed air diverted from the compressor section is at least 5% of an inlet flow at an inlet of a high pressure compressor of the compressor section. The flow of bleed air is provided to a thermal management system. The flow of bleed air is passed through an expansion turbine of the thermal management system. The flow of bleed air is provided to a thermal load.

The method of one or more of these clauses, further comprising providing the flow of bleed air to a first heat exchanger before the flow of bleed air is provided to the expansion turbine and cooling the flow of bleed air with the first heat exchanger.

The method of one or more of these clauses, further comprising providing a coolant to the first heat exchanger, wherein the coolant is provided from a fuel system, wherein the fuel system comprises a fuel tank; and a deoxygenation system positioned between and fluidly connected to the fuel tank and to the first heat exchanger.

The method of one or more of these clauses, wherein passing the flow of bleed air through the expansion turbine comprises: driving, with the flow of bleed air, a turbine element of the expansion turbine; expanding, with the expansion turbine, the flow of bleed air; and decreasing, with the expansion turbine, thermal energy of the flow of bleed air.

The method of one or more of these clauses, wherein passing the flow of bleed air through the expansion turbine further comprises generating an output torque via expanding the at least a portion of the flow of bleed air across the expansion turbine.

The method of one or more of these clauses, further comprising delivering the output torque from the expansion turbine to a generator.

The method of one or more of these clauses, further comprising delivering the output torque from the expansion turbine to a turbomachine of the propulsion system.

The method of one or more of these clauses, wherein the amount of the flow of bleed air diverted from the compressor section is greater than or equal to 10% and less than or equal to 25% of the inlet flow at the inlet of the compressor section.

The method of one or more of these clauses, wherein the amount of the flow of bleed air diverted from the compressor section is less than or equal to about 15% of the inlet flow at the inlet of the compressor section when a power level of the propulsion system is greater than 70% of a maximum rated power level of the propulsion system.

The method of one or more of these clauses, wherein the amount of the flow of bleed air diverted from the compressor section is at least about 15% of the inlet flow at the inlet of the compressor section when a power level of the propulsion system is less than 70% of a maximum rated power level of the propulsion system.

The method of one or more of these clauses, wherein the amount of the flow of bleed air diverted from the compressor section is greater than or equal to 5% of the inlet flow at the inlet of the compressor section when a power level of the propulsion system is greater than 75% of a maximum rated power level of the propulsion system.

The method of one or more of these clauses, wherein the amount of the flow of bleed air diverted from the compressor section is less than or equal to 10% of the inlet flow at the inlet of the compressor section when a power level of the propulsion system is greater than 75% of a maximum rated power level of the propulsion system.

The method of one or more of these clauses, wherein diverting the flow of bleed air from a compressor section of the propulsion system comprises diverting the flow of bleed air from a compressor section of the propulsion system to maintain a stall margin of the propulsion system of at least 10%.

A propulsion system includes a turbomachine and a thermal management system. The turbomachine includes a compressor section defining an inlet, a combustion section, and a turbine section in serial flow order. The thermal management system defines a thermal management system flowpath and is configured to receive a flow of bleed air extracted from the compressor section through the thermal management system flowpath. The thermal management system includes a first heat exchanger, an expansion turbine, and a thermal load. The first heat exchanger is thermally connected to the thermal management system flowpath and to the combustion section. The expansion turbine is fluidly connected to thermal management system flowpath at a location downstream of the first heat exchanger. The thermal load is thermally connected to the thermal management system flowpath. The thermal management system is configured to extract at least 5% of an inlet flow at an inlet of the compressor section from the compressor section.

The propulsion system of one or more of these clauses, wherein the compressor section comprises: a high pressure compressor; and a low pressure compressor, wherein the first heat exchanger is fluidly connected to the high pressure compressor and to the combustion section.

The propulsion system of one or more of these clauses, further comprising a fuel system comprising: a deoxygenation system fluidly connected to the first heat exchanger, wherein the fuel system is configured to provide a coolant to the first heat exchanger.

The propulsion system of one or more of these clauses, wherein the thermal management system includes a first line defining in part the thermal management system flowpath, wherein the first line is fluidly connected to and extends from the compressor section, wherein the compressor section comprises: a low pressure compressor; and a high pressure compressor, wherein the first line is fluidly connected to and extends from the high pressure compressor.

The propulsion system of one or more of these clauses, further comprising: a second line fluidly connected to and extending from an interface between the high pressure compressor and the combustion section; and a bleed port switch connected to the first line and to the second line.

The propulsion system of one or more of these clauses, further comprising: a gearbox operably coupled to the expansion turbine; and an electrical generator operably coupled to the gearbox, wherein the gearbox is configured to transfer rotational energy from the expansion turbine to the electrical generator.

The propulsion system of one or more of these clauses, wherein the thermal management system further comprises a recuperating heat exchanger fluidly connected between the first heat exchanger and the expansion turbine, and wherein the recuperating heat exchanger is fluidly connected between the thermal load and the turbine section.

1. A method of managing thermal energy in a propulsion system, the method comprising:
diverting a flow of bleed air from a compressor section of the propulsion system, wherein an amount of the flow of bleed air diverted from the compressor section is at least 5% of an inlet flow at an inlet of a high pressure compressor of the compressor section;
providing the flow of bleed air to a thermal management system;
passing the flow of bleed air through an expansion turbine of the thermal management system; and
providing the flow of bleed air to a thermal load.

2. The method of claim 1, further comprising:
providing the flow of bleed air to a first heat exchanger before the flow of bleed air is provided to the expansion turbine; and
cooling the flow of bleed air with the first heat exchanger.

3. The method of claim 2, further comprising:
providing a coolant to the first heat exchanger, wherein the coolant is provided from a fuel system, wherein the fuel system comprises:
a fuel tank; and
a deoxygenation system positioned between and fluidly connected to the fuel tank and to the first heat exchanger.

4. The method of claim 1, wherein passing the flow of bleed air through the expansion turbine comprises:
driving, with the flow of bleed air, a turbine element of the expansion turbine;
expanding, with the expansion turbine, the flow of bleed air; and
decreasing, with the expansion turbine, thermal energy of the flow of bleed air.

5. The method of claim 1, wherein passing the flow of bleed air through the expansion turbine further comprises:
generating an output torque via expanding the at least a portion of the flow of bleed air across the expansion turbine.

6. The method of claim 5, further comprising:
delivering the output torque from the expansion turbine to a generator.

7. The method of claim 5, further comprising:
delivering the output torque from the expansion turbine to a turbomachine of the propulsion system.

8. The method of claim 1, wherein the amount of the flow of bleed air diverted from the compressor section is greater than or equal to 10% and less than or equal to 25% of the inlet flow at the inlet of the compressor section.

9. The method of claim 8, wherein the amount of the flow of bleed air diverted from the compressor section is less than or equal to about 15% of the inlet flow at the inlet of the compressor section when a power level of the propulsion system is greater than 70% of a maximum rated power level of the propulsion system.

10. The method of claim 8, wherein the amount of the flow of bleed air diverted from the compressor section is at least about 15% of the inlet flow at the inlet of the compressor section when a power level of the propulsion system is less than 70% of a maximum rated power level of the propulsion system.

11. The method of claim 1, wherein the amount of the flow of bleed air diverted from the compressor section is greater than or equal to 5% of the inlet flow at the inlet of the compressor section when a power level of the propulsion system is greater than 75% of a maximum rated power level of the propulsion system.

12. The method of claim 1, wherein the amount of the flow of bleed air diverted from the compressor section is less than or equal to 10% of the inlet flow at the inlet of the compressor section when a power level of the propulsion system is greater than 75% of a maximum rated power level of the propulsion system.

13. The method of claim 1, wherein diverting the flow of bleed air from a compressor section of the propulsion system comprises diverting the flow of bleed air from a compressor section of the propulsion system to maintain a stall margin of the propulsion system of at least 10%.

14. A propulsion system comprising:
a turbomachine comprising a compressor section, a combustion section, and a turbine section in serial flow order, the compressor section defining an inlet;
a thermal management system defining a thermal management system flowpath and configured to receive a flow of bleed air extracted from the compressor section through the thermal management system flowpath, the thermal management system comprising:
a first heat exchanger thermally connected to the thermal management system flowpath and to the combustion section;
an expansion turbine fluidly connected to thermal management system flowpath at a location downstream of the first heat exchanger; and
a thermal load thermally connected to the thermal management system flowpath, wherein the thermal management system is configured to extract, from the compressor section, at least 5% of an inlet flow at an inlet of the compressor section.

15. The propulsion system of claim 14, wherein the compressor section comprises:
a high pressure compressor; and
a low pressure compressor, wherein the first heat exchanger is fluidly connected to the high pressure compressor and to the combustion section.

16. The propulsion system of claim 14, further comprising a fuel system comprising:
a deoxygenation system fluidly connected to the first heat exchanger, wherein the fuel system is configured to provide a coolant to the first heat exchanger.

17. The propulsion system of claim 14, wherein the thermal management system includes a first line defining in part the thermal management system flowpath, wherein the first line is fluidly connected to and extends from the compressor section, wherein the compressor section comprises:
a low pressure compressor; and
a high pressure compressor, wherein the first line is fluidly connected to and extends from the high pressure compressor.

18. The propulsion system of claim 17, further comprising:
a second line fluidly connected to and extending from an interface between the high pressure compressor and the combustion section; and
a bleed port switch connected to the first line and to the second line.

19. The propulsion system of claim 14, further comprising:
a gearbox operably coupled to the expansion turbine; and
an electrical generator operably coupled to the gearbox, wherein the gearbox is configured to transfer rotational energy from the expansion turbine to the electrical generator.

20. The propulsion system of claim 14, wherein the thermal management system further comprises a recuperating heat exchanger fluidly connected between the first heat exchanger and the expansion turbine, and wherein the recuperating heat exchanger is fluidly connected between the thermal load and the turbine section.
